(19) United States
(12) Patent Application Publication
(10) Pub. No.: US 2015/0302010 A1
(43) Pub. Date: Oct. 22, 2015

(54) METHODS FOR GENERATING FILE RELATIONSHIP DATA, AND MEDIA FILE SYSTEMS THAT GENERATE FILE RELATIONSHIP DATA

(71) Applicant: Quantel Limited, Berkshire (GB)

(72) Inventors: Simon Darryl Rogers, Berkshire (GB); James Westland Cain, Berkshire (GB); Michael James Weaver, Berkshire (GB)

(21) Appl. No.: 14/423,689

(22) PCT Filed: Aug. 14, 2013
(86) PCT No.: PCT/GB2013/052158

§ 371 Date: Feb. 24, 2015

(30) Foreign Application Priority Data
Sep. 5, 2012 (GB) 1215838.2

(51) Int. Cl. G06F 17/30

(52) U.S. Cl. CPC G06F 17/3007

(57) ABSTRACT

A method of generating, in a media file system comprising a data store and a file record database, file relationship data for a first media file in the media file system. The method determines essence data in the data store from which the first media file was derived, by determining from the file record for the media file in the file record database details of any previous media files in the media file system from which the media file was created. If the media file was not created from any previous media files, the essence data in the data store that constitutes the media file is determined from the file record. If on the other hand the media file was created from any previous media files, the previous steps are repeated for the previous media files. The file relationship data is generated using the details of the determined essence data.

### FIELD OF THE INVENTION

The present invention concerns methods for generating file relationship data for media files in a media file system, and media file systems that generate such file relationship data. More particularly, but not exclusively, the present invention concerns the generation of file relationship data that indicates how the contents of a media file relates to the contents of other media files in the media file system. The present invention also concerns methods for generating metadata for media files using generated file relationship data.

### BACKGROUND OF THE INVENTION

A known media file system is shown in FIG. 1. The file system 1 comprises a data store 2, a file record database 3, and a gateway 4. The data store 2 stores media data, in other words video and audio data, conventionally known as “essence” data. The file record database 3 contains file records that store the details of the files stored in the file system 1, in particular the location of the essence data in the data store 2 that constitutes the files, but also other metadata such as creation date, file length, permission information and other attributes.

Access to the file system 1 is provided by the gateway 4, which is connected via a network 5 to external devices 6, such as servers, personal computers (PCs) and the like. The network 5 may be a local area network (LAN) or a public network such as the Internet. The gateway 6 accepts requests to read/write files from the file system 1, for example, and in response reads/writes data to/from the data store 2 based on the file records in the file record database 3; similarly, the file system gateway 4 accepts requests to read/write to the file records in the file record database 3 itself.

In particular, the gateway 6 provides file data for the files from the essence data in the data store 2, with the file records in the file record database 3 defining which essence data should be used.

The data for a file in the file system 1 may simply be a single block of essence data in the data store 2, in which case the file record for the file in the file record database 3 simply contains details of the relevant block of essence data. Often, a file will consist of a block of video essence data and a corresponding block of audio essence data providing a soundtrack to the video, in which case the corresponding file record contains details of both blocks of essence data.

A file in the file system 1 may also be a “clip”, as shown in FIG. 2. Clips are new files that are created from files already stored within the file system 1, and so use essence data already stored in the data store 2. Clips are conventionally created by video editing software. The clip X of FIG. 2 consists of sections A′, B′ and C′ from blocks of essence data for files A, B and C respectively. Usually such a clip would also comprise a soundtrack comprised of a single block of audio essence data.

An advantage of a file in the file system 1 being created as a clip is that its file record in the file record database 3 does not need to contain details of a single unique block of essence data in the data store 2 that contains the file data for the file. Instead, the file record can contain details of the sections of the blocks of pre-existing essence data that make up the clip. This means that no additional essence data needs to be stored in the data store 2 for the new file, the file record can simply point to existing essence data. However, to a device 6 interacting with the gateway 6 the new file will appear the same as any other file, in the sense that the file data for the file will be returned as if it were a single block of essence data.

The file record for the file may contain metadata identifying the file as a clip, and describing how it was created. Such a description is sometimes referred to as an Edit Decision List (EDL). Various standardised formats for this metadata exist, such as Advanced Authoring Format (AAF) and XML Interchange Format (XMEML). The file record may contain other metadata such as copyright information and descriptive information about the file and its contents.

A more complicated clip is shown in FIG. 3. In this case, the clip Y consists of sections D′ and E′ from blocks of essence data for files D and E respectively. Between the sections D′ and E′ is a block of essence data for a file F. The file F was generated from sections D″ and E″ from files D and E respectively, and is a fade from D″ into E″ generated by video editing software. Thus, the clip Y when viewed appears to be the sections D′ and D″ from block D, faded into the sections E″ and E′ from block E.

It is important to note that while the block of essence data for F is derived from essence data already in the file store 1, it is itself a separate block of essence data in the file store 1. This is because the frames of video it contains are not present in either of the original blocks of essence data from which it is derived. New essence data may be generated in many other ways during the creation of a clip, for example a visual filter can be applied or graphical elements such as idents, headlines, news tickers and the like can be added to a section of video essence data. As another example, new essence data may be derived by having a first piece of video as part of a second piece of video, for example in a clip of a newsreader with footage showing on the screen over their shoulder. In the case of audio, new audio essence data may be generated by overlaying tracks (for example a voiceover combined with background music) or by varying the characteristics such as the volume of an audio track.

It is often desirable to be able to identify the files in which the essence data has been used. For example, the essence data may constitute a piece of footage which is subject to copyright and used in television programmes under license. In this case, there may be a need to identify where the footage is used to ensure that the terms of the license are being complied with. In particular, it may be necessary to identify where footage is used in a file even if it is not the original essence data that constituted the footage that is being used in that file, for example if the footage is being displayed over a newsreader's shoulder thus leading to new essence data being used in the file. It may be further be necessary to identify the amount of footage used, for example a license may be given to use at most 2 minutes of live footage from a sporting event. Similarly, it may be necessary to identify where music is used in a television programme, even though the music is mixed together with other audio such as a voiceover.

Conventionally, this identification is done by a person viewing the clips, for example a broadcast television programme, visually/aurally identifying any relevant copyright material in the programme, and manually making a record. This is extremely time intensive, and can be unreliable as the person may fail to identify material used.

In editing software, functionality is known that allows a user to jump from a particular frame in a clip to the same frame in the file from which the frame was obtained (a “backward” jump). This functionality is usually known as “Match Frame”. In some known media file systems the frames of essence data are given a unique ID (a GUID), and this GUID can be used to identify the essence data from which the frame derives. In other known file systems, the original file in which the frame are present can be determined from its path in the file system.

Further, functionality is known that allows a user creating a clip from a file to jump from a frame in that file to the same frame in the clip (assuming that frame is present in the clip), in other in the opposite direction to Match Frame (a “forward” jump). Accordingly, this functionality is known as “Reverse Match Frame”.

However, it can be seen that while related to the above-mentioned problem, Match Frame and Reverse Match Frame do not provide a solution. Further, Match Frame can only jump from a frame in a clip to the same frame in the original file, so will not work if the frame has been modified, for example due to a fade being made between sections of video. Reverse Match Frame is only able to identify where within a known clip currently being edited a frame from original file is located, and does not provide general functionality to identify any clips containing the frame.

The present invention seeks to mitigate the above-mentioned problems. Alternatively and/or additionally, the present invention seeks to provide methods for generating file relationship data for media files in a media file system, and media file systems that generate such file relationship data, where the file relationship data for the media files indicate how the contents of media files are related. Alternatively and/or additionally, the present invention seeks to provide methods for generating metadata for media files using generated file relationship data.

### SUMMARY OF THE INVENTION

In accordance with a first aspect of the invention there is provided a method of generating, in a media file system comprising a data store and a file record database, file relationship data for a first media file in the media file system, the method comprising the steps of:

determining the essence data in the data store from which the first media file was derived, by the steps of:
i) determining from the file record for the media file in the file record database details of any previous media files in the media file system from which the media file was created;
ii) if the media file was not created from any previous media files, determining from the file record the essence data in the data store that constitutes the media file;
iii) if the media file was created from any previous media files, repeating steps i) to iii) for the previous media files;

generating the file relationship data using the details of the determined essence data.

As the essence data in the data store is the video/audio data making up the media files in the media file store, the essence data from which the first media file was derived is the underlying content of the first media file. Further, as the essence data is determined recursively by considering the previous media file used to create a media file, the essence data determined is not merely that providing the file data for the first media file itself. Instead, the determined essence data is the original underlying essence data used to generate the essence data for the first media file, even if that original essence data is modified and/or combined with other essence data so that original essence data is not explicitly used as file data for the first media file. This means that the file relationship data, being generated from the determined essence data, can indicate a relationship between the first media file and another media file in the media file system (for example that the first media file contains content from the other media file) even when they do not use the same essence data as file data, because the essence data has been modified and/or combined with other essence data.

Advantageously, the file relationship data comprises details of the blocks of essence data in the data store from which the first media file was derived. This provides details of the underlying video/audio content, rather than a particular file containing that video/audio content. This is advantageous as a media file can contain many distinct pieces of video/audio content, for example the separate audio and video tracks, multiple tracks of audio, and/or multiple segments of video combined together. Providing details of the underlying essence data rather than the media files containing the essence data therefore allows the contents of the media file and its relationships to be more clearly described. However, alternatively and/or additionally the file relationship data may comprise details of the media files in the media file store constituted by the blocks of essence data in the data store from which the first media file was derived. In the case that the file relationship data comprises details of the blocks of essence data, the blocks of essence data may be identified using GUIDs. Alternatively, the blocks of essence data may be identified using the paths of the media files which they constitute. The file relationship data preferably comprises details of the sections of the blocks of essence data from which the first media file was derived. The sections may be identified by the identifying the frames making up the sections of the blocks. The frames may be identified using frame IDs.

Preferably, the file relationship data is provided in a relationship file associated with the media file. Alternatively, the file relationship data may be provided in the metadata for the media file in the file record database, in a separate database, or in any other suitable location.

Advantageously, in step i) the media file is a clip, and the details of the previous media files are obtained from metadata in the file record database describing how the clip was created. The metadata may be in AAF or XMEML format.

By considering the metadata describing how the clip was created, essence data from which the media file was derived even if the essence data was modified during creation of the clip. Further, other information from the metadata can be used to more accurately determine whether the essence data was in fact used to derive the media file. For example, the metadata can be used to determine which particular segments of a block essence data were used to derive the media file. Similarly, essence data may have been used during the creation process in such a way that its content is not in fact present in the media file. For example, audio data may have been present only at zero volume level, or video data may have been used completely faded out.

Advantageously, the method further comprises the steps of:

performing steps i) to iii) for a set of media files;

determining the subset of media files in the set of media files that are derived from essence data from which the first media file is derived;

generating the file relationship data for the first media file using the details of the determined subset of media files.

In this way, the file relationship data can indicate a relationship between the first media file and another media file even if the first media file was not created using the other media file (directly or otherwise). The file relationship data can therefore indicate “forward” links, in other words it can indicate media files related to the first media file because they were created using the first media file. Further, the file relationship data can indicate that media files are related because they are derived from the same essence data, even if neither media file was created using the other.

Preferably the set of media files includes all media files in the media file system. The set of media files may include further media files not present in the media file system.

Preferably, the file relationship data comprises details of the media files in the subset of media files. It may be that a media file is in the subset of media files if it is derived from frames of essence data from which the first media file is also derived. In other words, the subset may include only media files that share actual content with the first media file. Alternatively, it may be that a media file is in the subset of media files if it is derived the same block of essence data from which the first media file is derived, even if they are derived from distinct segments of the block of essence data, and so the media files do not share any actual content.

In accordance with a second aspect of the invention, there is provided a media file system comprising a data store and a file record database, wherein the media file system is arranged to generate file relationship data using any of the methods described above. The file record database may comprise file relationship data for a set of media files in the media file system. The set of media files may include all media files in the media file system. Alternatively, the file record database may be arranged to generate file relationship data for media files in response to a request for the file relationship data. In other words, the file relationship data may not be stored in the media file system, but generated on the fly when requested.

In accordance with a third aspect of the invention there is provided a method of determining the media files from which a first media file is derived, comprising the steps of:

generating the file relationship data for the first media file using any of the methods described above;

determining the media files from which a first media file is derived from the generated file relationship data.

In accordance with a fourth aspect of the invention there is provided a method of determining the media files in a set of media files derived from a first media file, comprising the steps of:

generating the file relationship data for the first media file using any of the methods described above where the subset of media files in the set of media files that are derived from essence data from which the first media file is derived is determined;

determining the media files that are derived from a first media file from the generated file relationship data.

In accordance with a fifth aspect of the invention there is provided a method of determining the subset of media files in a set of media files derived from a section of essence data, comprising the steps of:

generating the file relationship data for each media file in the set of media files using any of the methods described above where the subset of media files in the set of media files that are derived from essence data from which the first media file is derived is determined;

determining the subset of media files in the set of media files that are derived from the section of essence data from the generated file relationship data for each media file in the set of media files.

In accordance with a sixth aspect of the invention there is provided a method for generating metadata for a first media file, comprising the steps of:

generating the file relationship data for the first file using the method of any of steps 1 to 7;

generating the metadata using the generated file relationship data.

Thus, the file relationship data for the first media file may be used to generate metadata for the first media file. The metadata may indicate which media files the first media file is related to. Advantageously, the metadata is generated using the metadata of media files indicated in the generated file relationship data. In this way, metadata from a related media file may be used to generate/update the metadata of the first media file. For example, descriptive information such as copyright information might be copied from the metadata of the related media file.

In accordance with a seventh aspect of the invention there is provided a computer program product arranged, when executed, to perform any of the methods of generating file relationship data described above.

In accordance with a eighth aspect of the invention there is provided a computer program product arranged, when executed, to provide a media file system as described above.

In accordance with an ninth aspect of the invention there is provided a computer program product arranged, when executed, to perform any of the methods of determining media files or generating metadata described above.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 is a known media file system;

FIG. 2 is a diagram of a first clip in the media file system of FIG. 1;

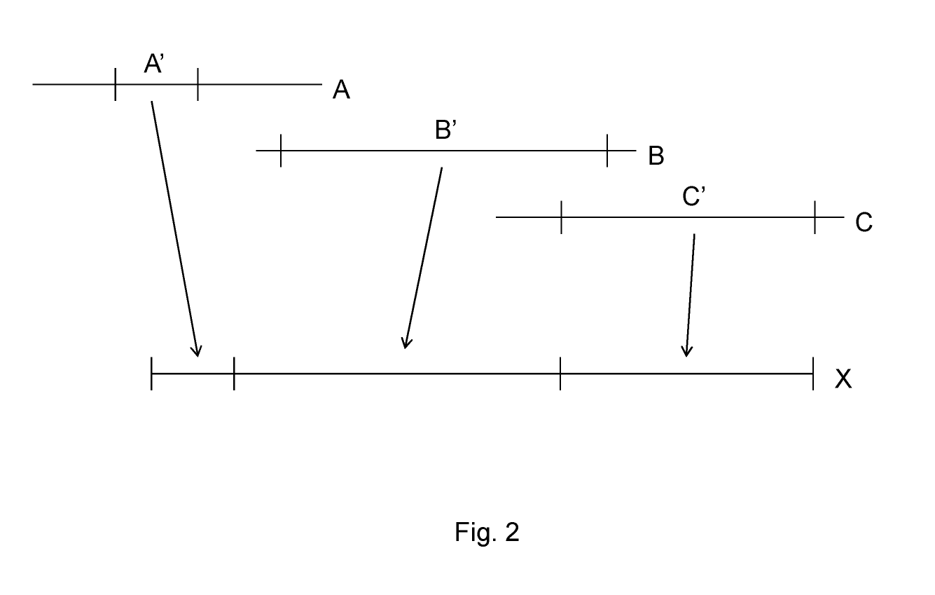

FIG. 3 is a diagram of a second clip in the media file system;

FIG. 4 is a flow chart describing how the blocks of essence data making up a media file are determined; and

FIG. 5 is a flow chart describing how the XML relationship file for a media file is created.

### DETAILED DESCRIPTION

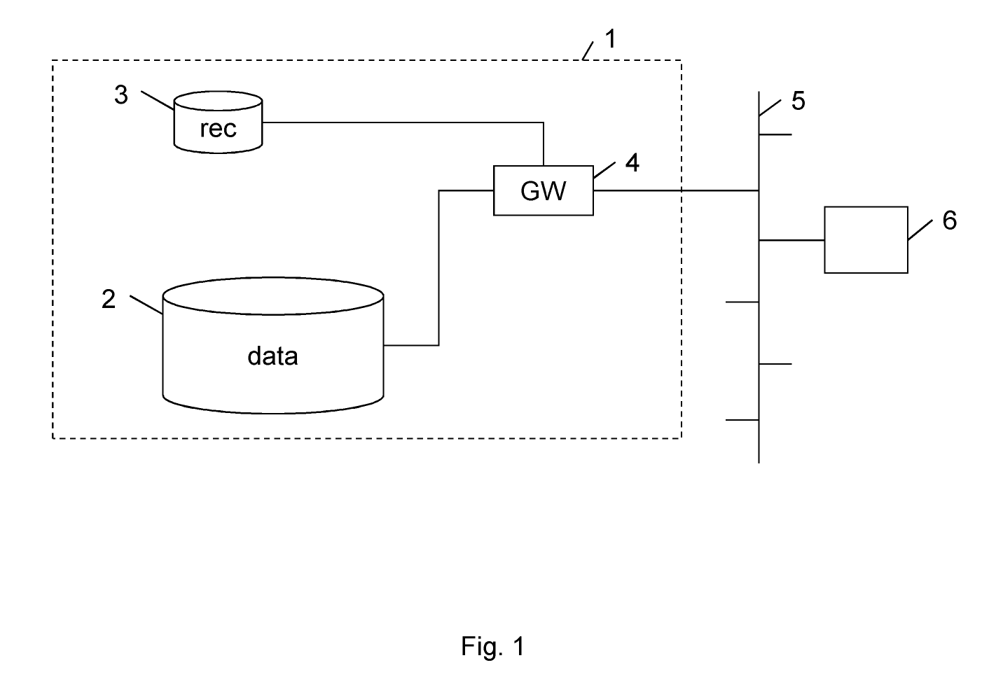

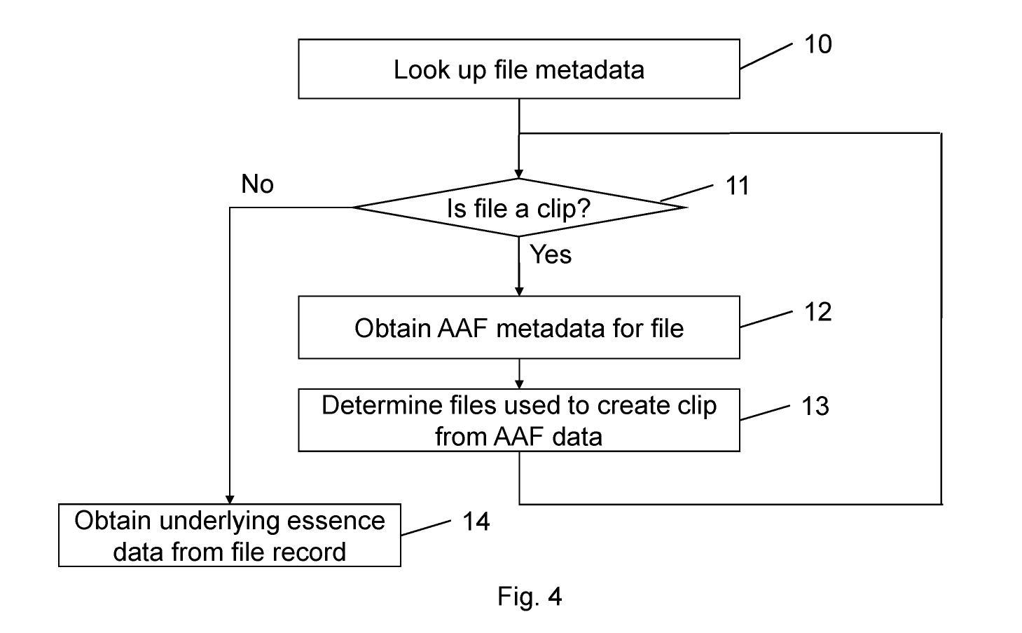

A first embodiment of the invention is now described with reference to FIGS. 4 to 6. The embodiment generates a relationship file for a media file stored in the media file system of FIG. 1. The relationship file is an XML file identifying the original block of essence data in the data store 2 making up the media file, and also any clips created using the same essence data. However, while in the present embodiment the relationship file provides a link between media files and blocks of essence data in the data store 2 making up the media file, in other embodiments the relationship file could instead provide a link between the file themselves.

The XML structure of the relationship file is a single <relations> block, containing a number of <clipSegment> blocks. Each <clipSegment> block describes a segment of the media file, which corresponds to a contiguous block of essence data making up the media file. A<clipSegment> block begins with a set of tags as follows:

<clipIn>0</clipIn>
<clipOut>182</clipOut>
<rushID>{10a64ea2-d190-40eb-b811-a2ae6e633d95}</rushID>
<rushIn>13664</rushIn>
<track>1</track>
<audio>0</audio>

The tags identify where the frames at which the segment begins (<clipIn>) and ends (<clipOut>) in the media file, which track of the media file the segment is (<track>), and whether it is an audio or video track (<audio>). The block of essence data in the data store 2 that provides the file data for the segment is identified by its GUID (<rushID>), and the frame within the essence data that begins the segment is identified (<rushIn>). (The end frame within the essence data can be calculated from the beginning frame and the length of the segment.) Thus, these tags provide a “backward” link from the segment to the essence data making up the segment.

A<clipSegment> block then contains a number of <clipPart> blocks. Each <clipPart> block identifies a segment of a clip created using the essence data used to create the current segment of the media file, in other words they provide a “forward” link from the essence data used to create the segment of the current media file to a clip created using the essence data. A<clipPart> block contains a set of tags as follows:

<clipID>8</clipID>
<clipIn>0</clipIn>
<clipOut>90000</clipOut>
<rushIn>0</rushIn>
<track>0</track>

The tags identify the clip by its ID (<clipID>), the beginning (<clipIn>) and ending (<clipOut>) frames of the segment of the clip, and the track of the clip. (The track will be an audio track if and only if the segment is an audio segment, of course.) The frame within the essence data which begins the segment of the clip is identified (<rushIn>) (and similarly the end frame within the essence data can be calculated from the beginning frame and the length of the segment of the clip).

FIG. 4 is a flowchart describing how the blocks of essence data making up the media file are determined. First, the metadata for the media file is looked up in the file record database 3 (step 10). The metadata is checked to determine if the media file is a clip, in other words if it is derived from other media files, or if it is an “original” file made up by a single block of essence data in the data store 2 (step 11). If the media file is not a clip, details of the essence data making up the file is returned (step 14).

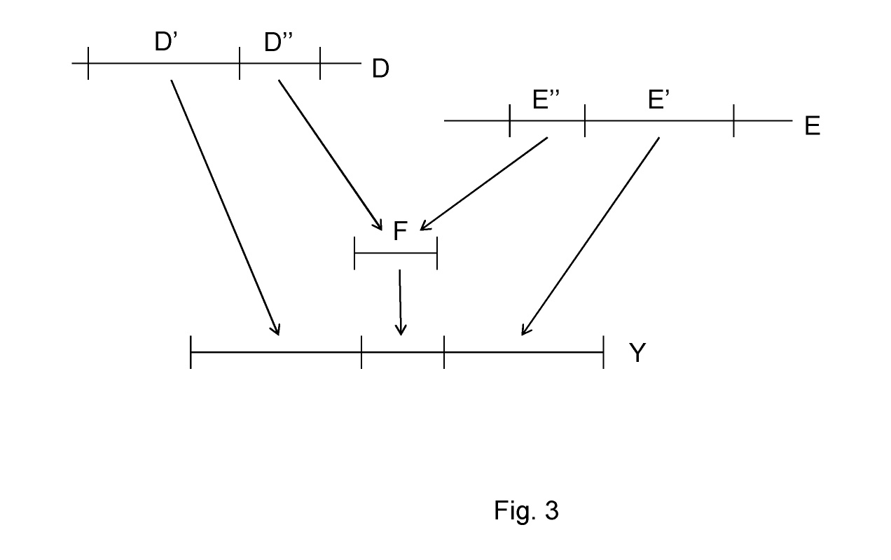

If on the other hand the media file is a clip, the AAF metadata describing the creation of the clip is obtained from the file record database 3 (step 12). The files used to create the media file are then obtained from the AAF metadata (step 13). For each file the steps are repeated to identify if the files are clips and to (recursively, if required) determine the details of the essence data underlying the files (steps 11 to 14). Note that in the case that a clip comprises new essence data generated from existing essence data, such as the segment F of clip Y in FIG. 3 which is a fade between to existing pieces of video, the AAF metadata is used to identify that the existing essence data underlying the new essence data, and in this way the original essence data from which a clip is created is identified even if the clip does not contain data (e.g. frames) explicitly found in the original essence data. For the clip Y of FIG. 3, therefore, the original essence data D″ and E″ will be returned, rather than the newly created intermediate essence data F. In alternative embodiments, details of both the original underlying essence data and any intermediate essence data are returned.

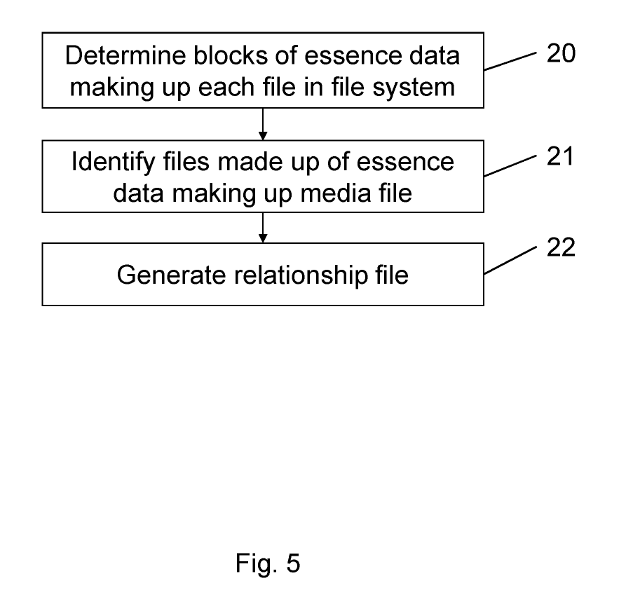

FIG. 5 is a flowchart describing how the XML relationship file for a media file is created. First, the blocks of essence data making up every file in the file system 1 are determined (step 20), using the method of FIG. 4. Using this, the files that share essence data with the current media file are then determined (step 21). The relationship file is then generated (step 22), with the file record data and obtained AAF metadata for the files providing the required frame beginning and end positions, track data and so on.

In the alternative embodiment described above in which details of intermediate essence data are returned, this can be used to provide further details in the relationship file. For example, the relationship file can indicate which media files that use the intermediate essence data (and what of the intermediate essence data they use), as well indicating that they use the original essence data underlying the intermediate essence data.

In another alternative embodiment, data on the blocks of essence data making up files is used to create the relationship file, where the files are not in the present media file system but are stored in a separate media file system. Such data can be used, as the essence data is identified using a GUID which is the same regardless of the media file system in which the essence data is stored. In this way, the relationship data file can indicate media files in other media file systems that use the essence data. For example, a provider of media files such as new footage might receive such data from customers, which would enable them to generate a relationship file indicating where the customers had used footage in the customer's media file systems.

Whilst the present invention has been described and illustrated with reference to particular embodiments, it will be appreciated by those of ordinary skill in the art that the invention lends itself to many different variations not specifically illustrated herein.

For example, it will be appreciated that the relationship file could be provided in formats other than XML, and indeed the relationship data could be included in an existing file such as a metadata file instead of in a separate file.

It will also be appreciated that alternative information could be used in the relationship data. For example, paths for media file constituting the essence data could be used instead of GUIDs for the essence data. Similarly, paths could be used to identify clips instead of clip IDs. Timing information could be used instead of frame numbers to identify segments of essence data, for example the time at which a segment begins and ends within a block of essence data.

1. A method of generating, in a media file system comprising a data store and a file record database, file relationship data for a first media file in the media file system, the method comprising the steps of:
determining the essence data in the data store from which the first media file was derived, by the steps of:
i) determining from the file record for the media file in the file record database details of any previous media files in the media file system from which the media file was created;
ii) if the media file was not created from any previous media files, determining from the file record the essence data in the data store that constitutes the media file;
iii) if the media file was created from any previous media files, repeating steps i) to iii) for the previous media files; and
generating the file relationship data using the details of the determined essence data.

2. A method as claimed in claim 1, wherein the file relationship data comprises details of the blocks of essence data in the data store from which the first media file was derived.

3. A method as claimed in claim 1, wherein the file relationship data is provided in a relationship file associated with the media file.

4. A method as claimed in claim 1, wherein in step i) the media file is a clip, and the details of the previous media files are obtained from metadata in the file record database describing how the clip was created.

5. A method as claimed in claim 1, further comprising the steps of:
performing steps i) to iii) for a set of media files;
determining the subset of media files in the set of media files that are derived from essence data from which the first media file is derived; and
generating the file relationship data for the first media file using the details of the determined subset of media files.

6. A method as claimed in claim 5, wherein the file relationship data comprises details of the media files in the subset of media files.

7. A method as claimed in claim 5, wherein a media file is in the subset of media files if it is derived from frames of essence data from which the first media file is also derived.

8. A media file system comprising a data store and a file record database, wherein the media file system is arranged to generate file relationship data, the media file system arranged to:
determine the essence data in the data store from which the first media file was derived, wherein determine the essence data includes:
i) determine from the file record for the media file in the file record database details of any previous media files in the media file system from which the media file was created;
ii) if the media file was not created from any previous media files, determine from the file record the essence data in the data store that constitutes the media file;
iii) if the media file was created from any previous media files, repeat steps i) to iii) for the previous media files; and
generate the file relationship data using the details of the determined essence data.

9. A media file system as claimed in claim 8, wherein the file record database comprises file relationship data for a set of media files in the media file system.

10. A media file system as claimed in claim 8, wherein the file record database is arranged to generate file relationship data for media files in response to a request for the file relationship data.

11. A method as claimed in claim 1, further comprising the step of:
determining the media files from which the first media file is derived from the generated file relationship data.

12. A method as claimed in claim 5, further comprising the step of:
determining the media files that are derived from the first media file from the generated file relationship data.

13. A method as claimed in claim 5, further comprising the step of:
determining the subset of media files in a set of media files that are derived from a section of essence data from the generated file relationship data for each media file in the set of media files.

14. A method as claimed in claim 1, further comprising the step of:
generating the metadata for the first media file using the generated file relationship data.

15. A method as claimed in claim 14, wherein the metadata is generated using the metadata of media files indicated in the generated file relationship data.

16. A computer program product for generating, in a media file system comprising a data store and a file record database, file relationship data for a first media file in the media file system, the computer program product arranged, when executed, to:
determine the essence data in a data store from which the first media file was derived, wherein determine the essence data includes:
i) determine from the file record for the media file in the file record database details of any previous media files in the media file system from which the media file was created;
ii) if the media file was not created from any previous media files, determine from the file record the essence data in the data store that constitutes the media file;
iii) if the media file was created from any previous media files, repeat steps i) to iii) for the previous media files; and
generate the file relationship data using the details of the determined essence data.

17-18. (canceled)

19. A media file system as claimed in claim 8, wherein the file relationship data comprises details of the blocks of essence data in the data store from which the first media file was derived.

20. A media file system as claimed in claim 8, wherein the file relationship data is provided in a relationship file associated with the media file.

21. A media file system as claimed in claim 8, wherein in i) the media file is a clip, and the details of the previous media files are obtained from metadata in the file record database describing how the clip was created.

22. A media file system as claimed in claim 8, the media file system arranged to:
perform i) to iii) for a set of media files;
determine the subset of media files in the set of media files that are derived from essence data from which the first media file is derived; and
generate the file relationship data for the first media file using the details of the determined subset of media files.

23. A media file system as claimed in claim 22, wherein the file relationship data comprises details of the media files in the subset of media files.

24. A media file system as claimed in claim 22, wherein a media file is in the subset of media files if it is derived from frames of essence data from which the first media file is also derived.
